(19) United States
(12) Patent Application Publication
(10) Pub. No.: US 2007/0083887 A1
(43) Pub. Date: Apr. 12, 2007

(54) Commercial augmentation

(75) Inventors: Srinivas Gutta, EINDHOVEN (NL); Petrus Gerardus Meuleman, Eindhoven (NL); Wilhelmus Franciscus Johannes Verhaegh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/578,639

(22) PCT Filed: Nov. 8, 2004
(86) PCT No.: PCT/IB04/52338

§ 371 Date: May 9, 2006

Related U.S. Application Data
(60) Provisional application No. 60/518,922, filed on Nov. 10, 2003.

(51) Int. Cl. H04N 5/445; G06F 3/00; G06F 13/00; H04N 7/025; H04N 7/10

(52) U.S. Cl. 725/35; 725/34; 725/46

(57) ABSTRACT

Commercials (200) such as television commercials are augmented by obtaining additional information (300) regarding an advertised product or service from a remote server (182, 184, 192, 194, 195) via a computer network (180) such as the Internet. Commercials are identified and descriptive information is extracted (170). The descriptive information may indicate, e.g., the type of commercial. A user provides preferences (400, 500) regarding commercials via an interface. The preferences may indicate a desired level of detail (500) for the additional information. For commercials whose descriptive information corresponds with the user preference, the computer network is searched to located additional information, e.g., in the form of a web page or link (300). The additional information may relate to promotions, availability, and specifications of an advertised product or service.

The invention relates generally to television and commercials and, more particularly, to a method and apparatus for providing additional information to a user, such as web page information, regarding the product or service advertised in a commercial. Advertisers use commercials to generate interest among potential consumers. They are usually displayed or played on TV or radio during the breaks of regular programs. Advertisements also pop up on the web as we navigate through the Internet. During the commercial, some producers provide the price of the product, and information for ordering the product, such as a telephone number for a mail order product. However, in most cases, commercials do not provide much specific information regarding an advertised product or service, for example, such as where the product or service can be purchased, the price, and the availability of the product or service. Commercials may avoid giving specific information because the same commercial is typically broadcast nationally and therefore cannot provide information that may be location-specific. Moreover, it would be expensive to modify the commercials for limited-time promotions.

Accordingly, it would be desirable to provide a method and apparatus for augmenting the information that is provided by a commercial that addresses the above and other issues.

In a particular aspect of the invention, a method is provided for obtaining information to augment commercials in a data stream. The method includes obtaining preference information from at least one user via a user interface, extracting descriptive information from commercials in the data stream, and determining, for each of the commercials, whether the extracted descriptive information corresponds with the preference information. Responsive to the determining step, the method further includes locating information from an external source, such as a server, via a computer network regarding at least one of the commercials whose extracted descriptive information corresponds with the preference information.

A related apparatus and program storage device are also provided.

In the drawings:

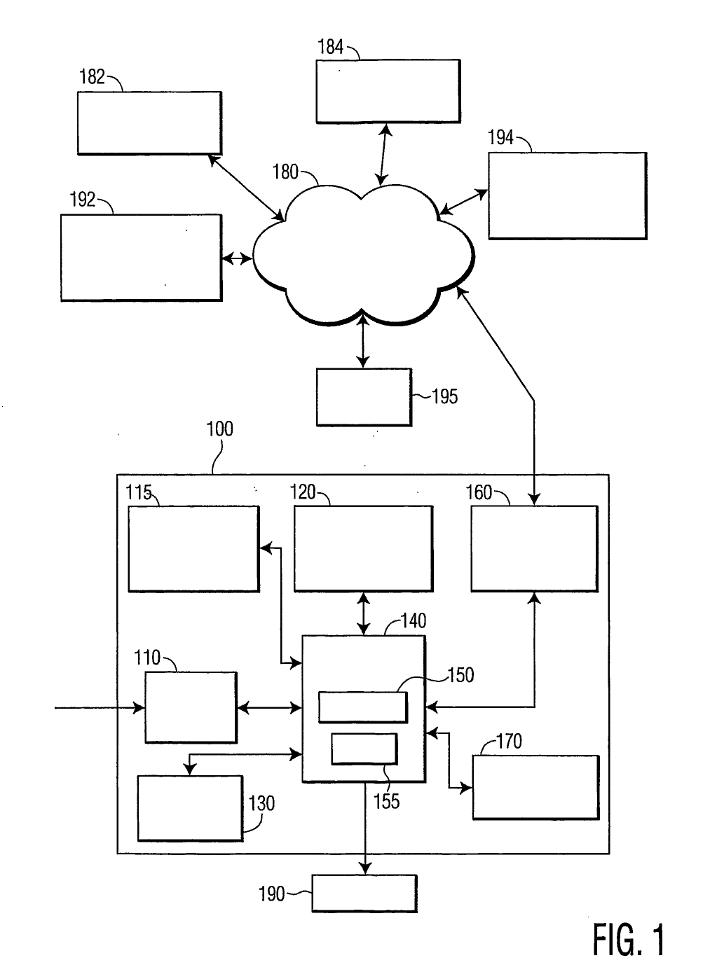

FIG. 1 illustrates an embodiment of an apparatus for obtaining information to augment commercials;

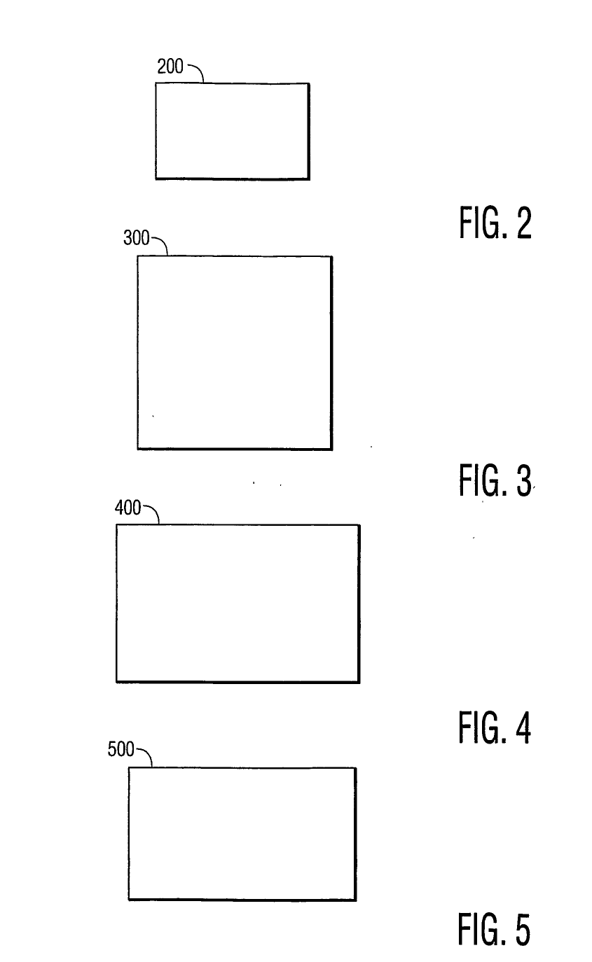

FIG. 2 illustrates an example commercial;

FIG. 3 illustrates an example display of information from a computer network that augments the commercial of FIG. 2;

FIG. 4 illustrates an example user interface for entering commercial preferences;

FIG. 5 illustrates an example user interface for selecting information detail; and

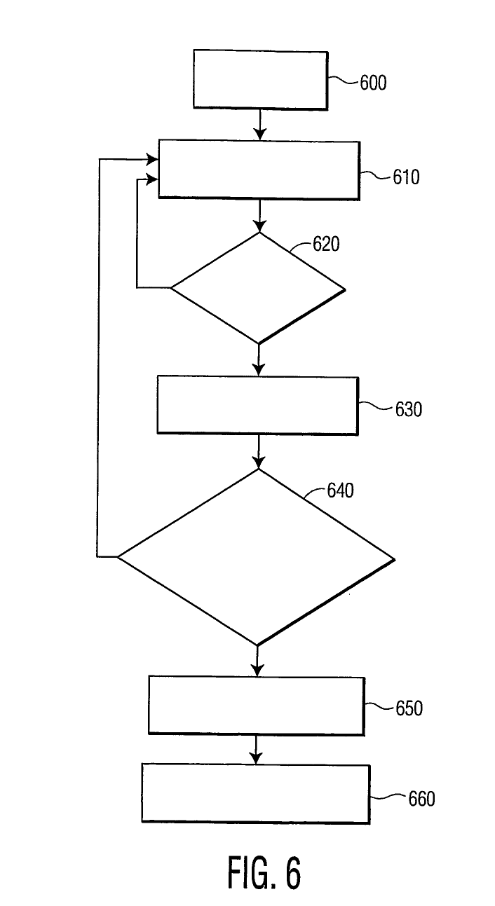

FIG. 6 illustrates an embodiment of a method for obtaining information to augment commercials.

In all the Figures, corresponding parts are referenced by the same reference numerals.

FIG. 1 illustrates an embodiment of an apparatus for obtaining information to augment commercials. In one possible approach, the invention is implemented using components within a television set-top box receiver that receives a television signal and outputs a signal for display on a television. However, the invention is generally applicable to any type of device that receives video and/or audio programs. For example, the invention may be implemented in a computer that receives video programs from a network such as the Internet, e.g., by downloading, streaming or broadcasting, such as webcasting. The video programs typically include an audio track although this is not required. Moreover, the invention can be used with audio-only programs such as those provided via the Internet, e.g., as webcasts, or via radio broadcasts, including terrestrial and satellite radio broadcasts.

In one approach, the receiver 100 demultiplexes and decodes the received programs at a demultiplexer/decoder 110. The programs may be provided in a digital or analog multiplex that is transmitted by cable, satellite, or terrestrial broadcast, for example. Generally, one of the programs is decoded based on a channel selection made by the user/viewer via a user interface 130. The decoded program may be communicated to a display device 190 via a CPU 140, which includes a working memory 150, or stored locally for subsequent display, e.g., at a video storage device 115. In one possible design, the working memory 150 is a program storage device that stores software that is executed by the CPU 140 to achieve the functionality described herein. However, resources for storing and processing instructions such as software to achieve the desired functionality may be provided using any known techniques.

A commercial extracter 170 scans the data stream carrying the selected video program to identify the location of commercials in the data stream, and to extract descriptive information from the commercials. This may be achieved using various techniques. For example, U.S. patent application Ser. No. 09/945,871 to Agnihotri et al., published Mar. 13, 2003 as US 2003/0050926, entitled “Method of using transcript information to identify and learn commercial portions of a program” and incorporated herein by reference, discusses a method for using transcript information, such as the closed-caption signal, to identify and learn commercial portions of a program. U.S. Pat. No. 6,469,749 to Dimitriva et al., issued Oct. 22, 2002, entitled “Automatic signature-based spotting, learning and extracting of commercials and other video content”, incorporated herein by reference, identifies segments in a video signal that are likely to be associated with a commercial. The extracted descriptive information could include the type of commercial—slow vs, fast; and category of commercial, such as a specific category of products or services, e.g., automobiles, restaurants, movies, etc. The user provides preference information, e.g., preferences, via a user interface 130 regarding characteristics of commercials in which the user is interested, as discussed further below. The extracted descriptive information of each commercial is compared to the preference information to determine if they correspond. For example, if the commercial has the word “coffee” spoken by an announcer, as determined by an audio-to-text conversion, a correspondence may exist when the user has expressed a preferences for coffee or coffee houses or a similar category of products, e.g., hot drinks, drinks with caffeine, or breakfast foods. Various artificial intelligence techniques may be used to determine whether the descriptive information of a commercial corresponds with the user preferences. If there is such a correspondence, an agent 155 is triggered, e.g., by implementing appropriate software in the CPU 140, to use a computer network interface 160 to obtain additional information regarding the commercial from an external source such as at least one remote server via a remote computer network 180 such as the Internet. Agent technology is well established and numerous techniques are available for locating information on the web or other computer networks. The additional information, as well as the commercial, may be stored at a commercial information storage device 120 such as a hard disk.

Various information sources communicate via the computer network 180. These may include servers provided by the advertisers for the commercials. For example, an advertiser “A” server 182 may provide information regarding a product or service “A”, while an advertiser “B” server 184 may provide information regarding a product or service “B”. The advertiser servers 182, 184 may be operated on behalf of an entity such as the manufacturer or producer of an advertised product or service, an advertising agency, or other intermediary. Additionally, in another option, entities that supply the products or services that are advertised in the commercials may provide information such as availability and pricing. For example, a product/service supplier “X” server 192 and a product/service supplier “Y” server 194 may be used. These are examples only. Additional servers may be employed, and one or more servers may consolidate information from other servers. For example, a product/supplier server may have information regarding different geographically dispersed locations such as individual retail stores in a chain of such stores where the advertised product or service can be purchased.

The agent 155 can obtain information from the network 180 in different ways. In one possible approach, the agent 155 provides information identifying the product or service “A” that was advertised in the commercial to the advertiser “A” server 182. In response, the advertiser “A” server 182 returns information such as specifications of the product or service, warranty information, a user's manual, health and safety warnings, pricing and special promotions, user testimonials, and the like, as applicable. Different information would be provided depending on the type of product, e.g., food vs. a household appliance. For example, the agent may identify the product as “Java brand coffee”, in which case the advertiser “A” server 182 may be operated on behalf of the Java brand company. The agent 155 may use intelligence that allows it to locate a specific advertiser's server based on the product name. The intelligence may be provided locally to the agent 155 or receiver 100 and/or at a location in the remote network 180. For example, the agent may connect to a specified agent server 195 that processes the agent's information to locate the associated server of the advertiser or product/service supplier. For instance, if the agent 155 provides the information “Java brand coffee” to the agent server 195, the agent server 195 may use a lookup table to identify the manufacturer, e.g., “General Coffee Corp.” and an associated URL of a web page that provide appropriate information to return to the agent 155. The web page may be provided by the advertiser “A” or “B” servers 182, 184, for example.

In another approach, the agent 155 provides information identifying the product or service “A” that was advertised in the commercial to one of the product/service supplier server 192, 194, along with information identifying the user's location, such as zip code or street address. This may be achieved directly or by using the agent server 195 as discussed above. For instance, if the agent 155 provides the information “Java brand coffee,” the agent server 195 may use a lookup table to identify the product supplier, e.g., “A&P Grocery Stores” and an associated URL of a web page that provides appropriate information to return to the agent 155. The web page may be provided by the product/service supplier “X” or “Y” servers 192, 194, for example. The product/service supplier “X” server 192, for instance, may provide information regarding a retail grocery store at which the product/service can be purchased, driving directions and driving time, store hours, distance from the user's home, and so forth. The product/service supplier “X” server 192 may access inventory information to inform the agent of whether the advertised product is in stock. Information regarding the availability of products at a retail store can be maintained using a computerized inventory system. Similarly, the product/service supplier “X” server 192 may access scheduling information to inform the agent 155 of when an appointment for a service, such as for car repair or hair cutting, is available. Note that preferred product/service suppliers may be identified based on a fee agreement so that their information is provided to the user via the agent. Note that the configuration shown in FIG. 1 is an example only. Moreover, the various components that store and process information need not be distinct components but their functions can be combined and carried out by common processing and storage elements.

FIG. 2 illustrates an example commercial 200 that is displayed on the display 190. The commercial advertises a product with the slogan “Buy Java brand coffee”. Assuming the extracted descriptive information of the commercial corresponds with the user preferences, the agent 155 may be triggered to locate information via the network 180 to augment the commercial. The located information may be displayed as the display 300 of FIG. 3.

FIG. 3 illustrates an example display of information from a computer network that augments the commercial of FIG. 2. Here, the information that is returned includes the message that “Java brand coffee is on sale for $2.99 per pound at stores A and B, which are at distances of 1 and 2 miles, respectively, from the user's home or other location. The information may be displayed in the form of one or more HTML web pages on the display 190, for example. A link to one or more web sites may be provided that the user can select to obtain further information. It is also possible for the agent 155 to receive the additional information regarding a commercial in the form of a multimedia file so that the information is provided in an entertaining video/audio presentation. Note that the agent 155 may locate information on the advertised product/service from competing entities, such as different grocery stores, so that the user can comparison shop. Different entities may be promoted over others based on fee agreements.

The additional information regarding a commercial that may be provided to the user includes: price of the product/service, ordering information for mail orders, where the product or service can be purchased, price, financing/credit terms, availability of the product or service, schedule availability for services such as car repair, hair cutting, dentist office visits, etc., colors/patterns/styles, special promotions being offered by a retail store or by the manufacturer, dates of promotions, distance from user's home to closest retail store with driving directions, identity of the manufacturer and place of manufacture, service information such as maintenance and cleaning requirements, warranty information, health/safety warnings, return policy, product/service ratings, and product/service reviews.

FIG. 4 illustrates an example user interface 400 for entering commercial preferences. The user interface 400 allows the user to enter preference information regarding characteristics of commercials in which the user is interested. Characteristics that are undesired can be indicated as well. A degree of interest or disinterest can also be indicated. The user may optionally provide weights indicating the relative importance of various characteristics of the commercials.

For example, the user may enter preferences by commercial type, keyword, music, performer, and sample. The commercial type or category may be a tempo or energy level of the commercial, such as slow, medium or fast, or a type of product or service, e.g., automobiles, clothing, food, restaurants and movies, for instance. The keyword can be one or more keywords identifying a product or service of interest, e.g., “Mercedes Benz” or “coffee”, for instance. Text can be obtained from the commercials by converting an audio portion of the commercials to text, or by using the closed caption text, and using any type of text matching technique. The music can be a music track in the commercial, such as the name of a song or musical group. The music can be matched to the preferences by converting the words, if any, to text and performing a text comparison to a library of songs, or by matching the notes to a song library, or by other known techniques. See, e.g., H. Harb et al., A Query By Example Music Retrieval Algorithm, Maths-Info Dept., Ecole Centrale de Lyon, France, http://citeseer.je.nec.com/583447.html (2001).

The performer can be the name of a performer such as an actor that is in the commercial. The performer can be recognized if the name is spoken and converted to text, or is indicated in the closed caption text. Or, to detect an actor in a commercial, one can use face recognition. Recognition of people via faces is well known in the art. To recognize a face, the user has to first give a sample image of the face, and the system needs to be trained. Once it is trained, it can detect and recognize faces in a commercial. See, e.g., Srinivas Gutta and Harry Wechsler, Face Recognition Using Hybrid Classifiers, Pattern Recognition, Vol. 30, No. 4. (1997), incorporated herein by reference.

The sample can be examples of commercials (video and/or audio samples) that the user has identified in the past as being of interest. If the user provides samples of commercials, then the system first extracts descriptive information about the commercial then formats the descriptive information to fill the user interface. For example, the user may use an interface to designate, over a period of days, for instance, commercials that the user likes. The identified commercials can be stored and analyzed, such as by analyzing their closed caption data or by converting the audio to text. Artificial intelligence techniques are used to determine, e.g., which words are important and classify the commercials accordingly. For example, a commercial for a car can be analyzed to obtain the model name and manufacturer, type of background music played, if any, as well as characteristics of the commercial such as its pace, e.g., fast paced or slow paced. The information from the various identified commercials can be aggregated and averaged over time to determine the user's preferences.

Generally, any type of available artificial intelligence can be used for providing the user preference information and the descriptive information from the commercials, and determining whether there is a correspondence.

FIG. 5 illustrates an example user interface 500 for selecting information detail. The interface 500 allows the user to select a level of detail, or amount of information, regarding the information that is located to augment the commercial. For example, if the advertised product is an automobile, a basic level of detail may provide overview information such as base price, available body styles, mileage, etc. The moderate level of detail may provide further information such as important safety and convenience features. The detailed level of detail may provide further information such as optional equipment and prices, and warranty details. Or, the level of detail may be provided on a 1 to 5 scale, where 5 represent the most detail.

Various other criteria can be entered by the user to customize the display of information. For example, the user may designate preferred product/service suppliers and a maximum distance that the user is willing to travel so that locations outside this distance are not displayed to the user.

FIG. 6 illustrates an embodiment of a method for obtaining information to augment commercials. At block 600 (“obtain user preferences”), the user preferences are obtained regarding desired or undesired characteristics of the commercials. At block 610 (“scan data stream to detect commercials”), the received data stream (e.g., video and/or audio data stream) is scanned to detect all commercials in the data stream. The system may continuously scan the video and/or audio content for commercials. If a commercial is detect (block 620—“commercial detected?”), then descriptive information about the commercial is extracted (block 630—“extract descriptive information”), and it is determined whether the extracted descriptive information matches or otherwise corresponds with the user preference information (block 640—“descriptive information corresponds with user preferences?”). If no commercial is detected (block 620), or the extracted descriptive information does not correspond with the user preference information (block 640), the data stream continues to be scanned (block 610).

If there is a correlation (block 640), then additional information about the commercial is searched for from a remote server via a computer network 180 such as the web. In particular, the agent 155 locates information via the computer network 180 to augment the commercial (block 650—“location information via computer network”). As discussed previously, relevant information that may be retrieved includes the stores at which the product is sold, discounts offered, the expiration date of the discounts, price, warranty information, manufacturer information, how far the store is from the user's location, return information, product ratings, product reviews, etc. At block 660 (“display and/or store information and/or link”), the retrieved information and/or a link to the information may be displayed and/or stored. For example, the retrieved information may be displayed to the user as a link such as a hyperlink, or it could automatically create a web page and store it, e.g., at the commercial information storage device 120, along with the commercial, or provide it for viewing on a dynamically-created commercial channel.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for obtaining information to augment commercials in a data stream, comprising:
obtaining preference information from at least one user via a user interface (130, 400, 500);
extracting descriptive information from commercials (200) in the data stream;
determining, for each of the commercials, whether the extracted descriptive information corresponds with the preference information; and
responsive to the determining step, locating information from an external source via a computer network (180) regarding at least one of the commercials whose extracted descriptive information corresponds with the preference information.

2. The method of claim 1, wherein:
the external source comprises at least one server (182, 184, 192, 194, 195).

3. The method of claim 1, wherein:
the data stream comprises at least one video program.

4. The method of claim 1, wherein:
the data stream comprises at least one audio program.

5. The method of claim 1, further comprising:
displaying the located information to the at least one user on a display device (190).

6. The method of claim 1, further comprising:
displaying a link to the located information to the at least one user on a display device (190).

7. The method of claim 1, further comprising:
storing the located information on a storage device (120) for subsequent retrieval by the at least one user.

8. The method of claim 1, wherein:
the located information comprises information regarding a product or service advertised in the at least one of the commercials whose extracted descriptive information corresponds with the preference information.

9. The method of claim 1, further comprising:
scanning the video stream to detect the commercials;
wherein the extracting descriptive information step is performed for commercials detected in the scanning step.

10. The method of claim 1, wherein:
the obtaining preference information step comprises obtaining a user input (500) indicating an amount of information that is desired to be obtained from the external source for the at least one of the commercials whose extracted descriptive information corresponds with the preference information.

11. The method of claim 1, wherein:
the obtaining preference information step comprises obtaining information (400) identifying at least one category of commercials.

12. The method of claim 1, wherein:
the obtaining preference information step comprises obtaining information (400) identifying at least one music track.

13. The method of claim 1, wherein:
the obtaining preference information step comprises obtaining information (400) identifying at least one performer.

14. The method of claim 1, wherein:
the obtaining preference information step comprises identifying at least one sample commercial by the at least one user via the user interface (400), and extracting descriptive information from the at least one sample commercial.

15. The method of claim 1, wherein:
the obtaining preference information step comprises obtaining at least one keyword from the at least one user via the user interface (400);
the extracting descriptive information step comprises extracting text from the commercials; and
the extracted descriptive information corresponds with the preference information when the extracted text corresponds with the at least one keyword.

16. The method of claim 15, wherein:
the extracting text from the commercials comprises extracting text from closed captioned data of the commercials.

17. The method of claim 15, wherein:
the extracting text from the commercials comprises converting an audio portion of the commercials to text.

18. An apparatus for obtaining information to augment commercials in a data stream, comprising:
means (130, 400, 500) for obtaining preference information from at least one user;
means (170) for extracting descriptive information from commercials (200) in the data stream;
means (140) for determining, for each of the commercials, whether the extracted descriptive information corresponds with the preference information; and
means (155), responsive to the determining step, for locating information from an external source via a computer network (180) regarding at least one of the commercials whose extracted descriptive information corresponds with the preference information.

19. The apparatus of claim 18, wherein:
the external source comprises at least one server (182, 184, 192, 194, 195).

20. A program storage device tangibly embodying a program of instructions executable by a machine to perform a method for obtaining information to augment commercials in a data stream, the method comprising:
obtaining preference information from at least one user via a user interface (130, 400, 500);
extracting descriptive information (170) from commercials (200) in the data stream;
determining, for each of the commercials, whether the extracted descriptive information corresponds with the preference information; and
responsive to the determining step, locating information (300) from an external source via a computer network (180) regarding at least one of the commercials whose extracted descriptive information corresponds with the preference information.
